(19) United States
(12) Patent Application Publication
(10) Pub. No.: US 2008/0201755 A1
(43) Pub. Date: Aug. 21, 2008

(54) BROADCAST RECEIVING SYSTEM

(75) Inventor: Yuuki Okamoto, Osaka (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., Osaka (JP)

(21) Appl. No.: 12/031,547

(22) Filed: Feb. 14, 2008

(30) Foreign Application Priority Data
Feb. 16, 2007 (JP) 2007-035684

(51) Int. Cl. H04N 7/173

(52) U.S. Cl. 725/117

(57) ABSTRACT

The present invention provides a broadcast receiving system capable of receiving programs with a secondary viewing terminal device(s) even when a primary viewing terminal device is not turned on, and detecting a secondary viewing terminal device(s) used in an unauthorized manner. When device authentication between the secondary viewing terminal device and the primary viewing terminal device is established through a communication line, viewing is allowed for the secondary viewing terminal device. When the device authentication is not established, viewing is controlled for the secondary viewing terminal device based on viewing restriction information generated by the center device based on the power status of the primary viewing terminal device.

### FIELD OF THE INVENTION

The present invention relates to a broadcast receiving system, such as a CATV system having a bidirectional communication function, that can detect unauthorized use of viewing terminal devices caused by, for example, the lending out of a viewing terminal device of a subscriber under contract to a non-subscriber and the installation of the viewing terminal device in a house other than the subscriber's house, and more particularly to a broadcast receiving system that can control the viewing terminal devices so as to prevent such unauthorized use.

### BACKGROUND OF THE INVENTION

Generally, in CATV (cable television) systems, a single viewing terminal device, such as a set-top box, is installed in the house of a subscriber. However, if the family members of a subscriber under contract each individually want to view distributed programs, the number of viewing terminal devices equal to the number of family members who want individual viewing is required, even within the same household. Conventional billing systems require subscribers to pay the service provider according to the number of viewing terminal devices they own, making the cost that the subscribers have to pay high.

In order to reduce the financial burden placed on the subscribers, most service providers offer fees for the second and subsequent viewing terminal devices that are much lower than the fees for the first viewing terminal device. For example, a kind of reverse progressive billing, such as 3,000 yen per month for the first primary viewing terminal device and 500 yen per month for each of the second and subsequent secondary viewing terminal devices, is employed. Because the same usage fee is charged for the second and subsequent viewing terminal devices, this example is not reverse progressive billing in the strict sense, but is called reverse progressive billing or reverse progressive fee in order to distinguish from a billing plan in which the same fee is charged for the primary viewing terminal device and for the secondary viewing terminal devices.

With this reverse progressive billing plan, subscribers have little hesitation in signing a contract for using a plurality of viewing terminal devices (one primary viewing terminal device and at least one secondary viewing terminal device) even in one household. Also, there is an advantage for service providers in that the fee revenue per household can be increased, which leads to an increase in the number of subscribers. The main purpose of this reverse progressive billing is to reduce the financial burden of the subscribers who use a plurality of secondary viewing terminal devices in addition to the primary viewing terminal device in one household (house). Of course, this system is based on the premise that all the viewing terminal devices are installed in the same house of the same subscriber.

However, the secondary viewing terminal devices can be utilized in an unauthorized manner by outsmarting the billing plan. For example, a case may arise where a household signs a contract for two viewing terminal devices (a primary viewing terminal device and one secondary viewing terminal device), after that, the secondary viewing terminal device is given or lent out to a non-subscriber's house located in the same CATV system network without the permission of the service provider. In such a case, under normal conditions, the usage fee for the primary viewing terminal device should be paid to the service provider by each of these two different households according to the reverse progressive billing system mentioned above (in the above case, 3,000 yen per month×2=6,000 yen).

However, the service provider cannot discover the fact that one secondary viewing terminal device has been lent to a neighbor. As long as the subscriber who has given the secondary viewing terminal device pays the contracted subscription fee for the two viewing terminal devices (one primary viewing terminal device and one secondary viewing terminal device) (e.g., 3,500 yen in the above case), the service provider will not discover the fact that the neighbor is conducting the unauthorized use of a primary viewing terminal device without paying the usage fee. In this case, the loss for the service provider is the difference between the fee for the primary viewing terminal device and that for the secondary viewing terminal device (6,000 yen−3,500 yen=2,500 yen). Because the devices themselves are identical, the only difference being that different fees are charged for the primary viewing terminal device and the secondary viewing terminal devices, and contract management is not carried out, commonly-used CATV systems cannot detect and prevent such unauthorized use.

As a method for detecting such unauthorized use, a method for detecting the unauthorized use of a viewing terminal device has been proposed in which movement of a viewing terminal device is detected by, for example, measuring the time used for communication between the viewing terminal device and the center device installed in a CATV station (for example, Japanese Laid-Open Patent Publication No. Hei 10-32806, hereinafter referred to as Patent Document 1). Also, a method for eliminating unauthorized viewing has been proposed in which network authentication is required between the primary viewing terminal device and a secondary viewing terminal device to allow the secondary viewing terminal device to receive a broadcast program (for example, Japanese Laid-Open Patent Publication No. Hei 10-322676, hereinafter referred to as Patent Document 2).

The above method for detecting movement of a viewing terminal device (Patent Document 1) cannot detect unauthorized use if the viewing terminal device is installed outside the contract area at the time of initial installation. Currently, to start a subscription to CATV, a worker is usually dispatched to the subscriber's house to install the viewing terminal devices, so the above method is effective. However, this method cannot detect unauthorized use in cases such as where the subscriber has installed the viewing terminal devices by him or herself, and therefore it is impossible to completely eliminate all unauthorized use.

On the other hand, according to the method based on the network authentication between the primary viewing terminal device and a secondary viewing terminal device (Patent Document 2), the primary viewing terminal device must be turned on whenever program viewing is performed with the secondary viewing terminal device. For example, when attempting program viewing with a secondary viewing terminal device installed in a bedroom upstairs, if the primary viewing terminal device installed in a living room downstairs is not turned on, the user must go to the living room downstairs to turn on the primary viewing terminal device, and then return upstairs to view the program, which is troublesome for the user.

### BRIEF SUMMARY OF THE INVENTION

It is an object of the present invention to provide a broadcast receiving system capable of receiving broadcast programs with a secondary viewing terminal device(s) even when the primary viewing terminal device is not turned on, and detecting a secondary viewing terminal device(s) used in an unauthorized manner.

In order to achieve the above object, a broadcast receiving system according to the present invention is provided with one primary viewing terminal device and a predetermined number of secondary viewing terminal devices subordinate to the primary viewing terminal device, and that performs bidirectional communication between the primary viewing terminal device and a center device, and between the secondary viewing terminal device and the center device, wherein the center device generates secondary viewing restriction information regarding the viewing control of the secondary viewing terminal devices based on at least the power status of the primary viewing terminal device, and the secondary viewing terminal device includes: a viewing terminal device authentication means for authenticating that the secondary viewing terminal device is installed in the same house as the primary viewing terminal device; a viewing restriction information acquisition means for acquiring the secondary viewing restriction information from the center device; and a viewing control means for controlling the viewing of programs broadcast from the center device based on the result of the authentication performed by the viewing terminal device authentication means and the acquired secondary viewing restriction information.

The present invention can detect the unauthorized use of a viewing terminal device(s) caused by the lending out of a secondary viewing terminal device(s) to the house of a neighbor, or the like, by a subscriber who has signed a contract for a plurality of viewing terminal devices for CATV service or the like.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a block diagram illustrating the configuration of a broadcast receiving system according to an embodiment of the present invention.

FIG. 2 is a block diagram illustrating the configuration of a center device of FIG. 1.

FIG. 3 is a block diagram illustrating the configuration of the primary viewing terminal device of FIG. 1.

FIG. 4 is a block diagram illustrating the configuration of a secondary viewing terminal device installed in the same house as the primary viewing terminal device of FIG. 1.

FIG. 5 is a block diagram illustrating the configuration of a secondary viewing terminal device installed in a house other than the subscriber's house where the primary viewing terminal device of FIG. 1 is installed.

FIG. 6 is a flowchart illustrating an operation for receiving programs with the secondary viewing terminal devices of FIG. 1.

FIG. 7 is a table used to illustrate the viewing restriction of the primary viewing terminal device and secondary viewing terminal devices of FIG. 1.

FIG. 8 is a flowchart illustrating an operation for transmitting viewing restriction information performed by the center device of FIG. 1.

### DETAILED DESCRIPTION OF THE INVENTION

### Embodiment 1

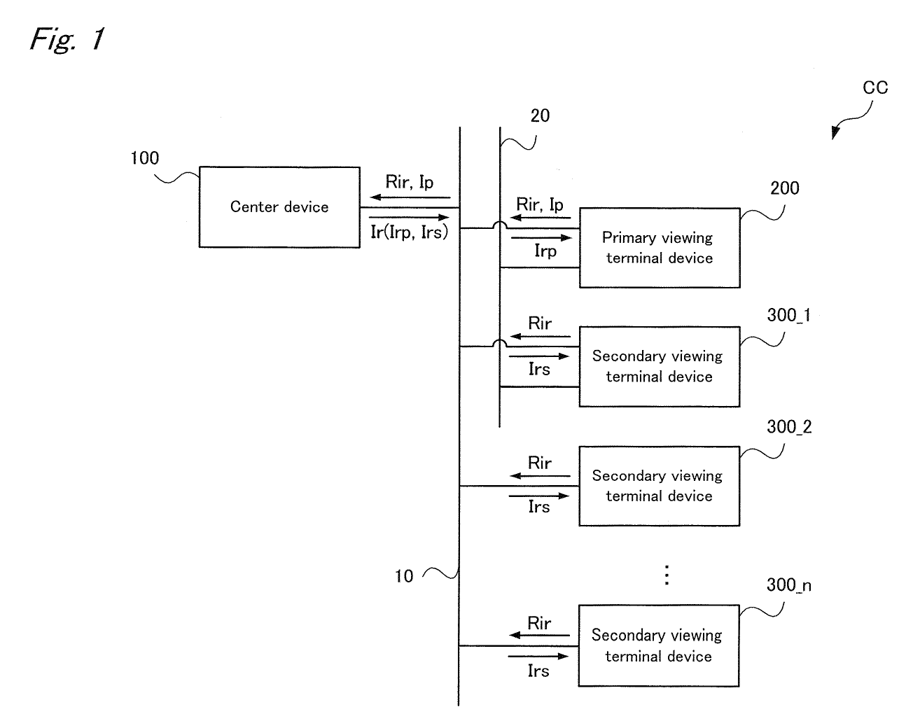

Hereinafter, a broadcast receiving system according to an embodiment of the present invention will be described with reference to the accompanying drawings. As shown in FIG. 1, a broadcast receiving system CC includes a communication line 10, a communication line 20, a center device 100, a single primary viewing terminal device 200, and n (n being any natural number) secondary viewing terminal devices 300_1 to 300_{—}n. The center device 100 is installed in a base station that broadcasts television through a network such as a CATV network. The primary viewing terminal device 200 and the secondary viewing terminal devices 300_1 to 300_{—}n each are connected to the center device 100 through the communication line 20.

Herein, the primary viewing terminal device 200 and the secondary viewing terminal devices 300_1 to 300_{—}n may generally be called a “viewing terminal device”. Similarly, the secondary viewing terminal devices 300_1 to 300_{—}n may collectively be called a “secondary viewing terminal device 300”. The communication line 10 is configured of a signal transmitting means such as a coaxial cable or fiber-optic cable, and connects the primary viewing terminal device 200 and the secondary viewing terminal device 300 to the center device 100. The network as described above in which the devices are connected to each other by a coaxial cable is called a “coaxial network”.

The primary viewing terminal device 200 and the secondary viewing terminal device 300 can be, for example, set top boxes, television sets, or the like, and have functionality for receiving broadcasts from the base station and demodulating the broadcasts. Normally, in order to actually receive programs with the viewing terminal devices such as the primary viewing terminal device 200 and the secondary viewing terminal device 300, the user who owns the viewing terminal devices has to have signed a contract with a service provider that provides a broadcasting service to obtain permission for receiving the service from the service provider.

For the sake of simplicity, this embodiment will be described in a context where the user has signed a contract for using a plurality of viewing terminal devices (one primary viewing terminal device 200 and two (n=2) secondary viewing terminal devices 300_1 and 300_2). The primary viewing terminal device 200 and the secondary viewing terminal devices 300_1 and 300_2 may be the same or different in terms of performance or functionality.

As with the primary viewing terminal device 200, the secondary viewing terminal device 300_1 is also installed in the house of the subscriber under contract. The secondary viewing terminal device 300_2 has been lent out to a neighbor, or the like, and thus is installed in a house other than the subscriber's house where the primary viewing terminal device 200 is installed. In other words, one of the three viewing terminal devices covered by a contract formally made by the broadcast subscriber with the service provider, namely, the secondary viewing terminal device 300_2, is installed, without authorization, in the house of a neighbor of the subscriber without a subscription. Video content broadcast from the center device 100 is transmitted to the primary viewing terminal device 200 and the secondary viewing terminal devices 300_1 and 300_2 through the communication line 10. In short, the center device 100 serves as a broadcast source for broadcasting video content in the broadcast receiving system CC. It should be understood that the number of viewing terminal devices is not limited in the present invention.

The communication line 10 is also used for bidirectional communication of information other than video content, as typified by electronic program guides and viewing restriction information of each viewing terminal device, performed between the center device 100 and the primary viewing terminal device 200 and the secondary viewing terminal devices 300_1 and 300_2. The video signals including video content and the control signals including control information and the like are transmitted separately according to frequency or in time series.

The communication line 20 connects the primary viewing terminal device 200 and the secondary viewing terminal device 300_1 in a wired or wireless manner in the subscriber's house, forming a local area network (LAN). Bidirectional communication is performed between the primary viewing terminal device 200 and the secondary viewing terminal device 300_1 through the communication line 20. In this embodiment, the communication lines 10 and 20 perform communication physically through the same medium. In this case, the communication signals of the communication line 10 and those of the communication line 20 are separated in a logical sense according to frequency or in time series. Of course, it goes without saying that the communication line 20 and the communication line 10 may be different media. The secondary viewing terminal device 300_2 is installed in the house of a neighbor of the subscriber, and therefore is not connected to the communication line 20 constituting the LAN of the subscriber's house.

The primary viewing terminal device 200 transmits a viewing restriction information request Rir and power status information Ip to the center device 100 through the communication line 10. In response to the viewing restriction information request Rir, the center device 100 transmits primary viewing restriction information Irp, indicative of the allowance/non-allowance of viewing for the primary viewing terminal device 200, to the primary viewing terminal device 200.

Similarly, the secondary viewing terminal device 300 transmits a viewing restriction information request Rir to the center device 100 through the communication line 10. In response to the viewing restriction information request Rir, the center device 100 transmits secondary viewing restriction information Irs indicative of the allowance/non-allowance of viewing for the secondary viewing terminal device 300 to the secondary viewing terminal device 300. The exchange of the viewing restriction information request Rir, the power status information Ip, and the viewing restriction information Ir between the center device 100, the primary viewing terminal device 200, and the secondary viewing terminal device 300 will be described in detail later. Herein, the primary viewing restriction information Irp and the secondary viewing restriction information Irs may be collectively called “viewing restriction information Ir”.

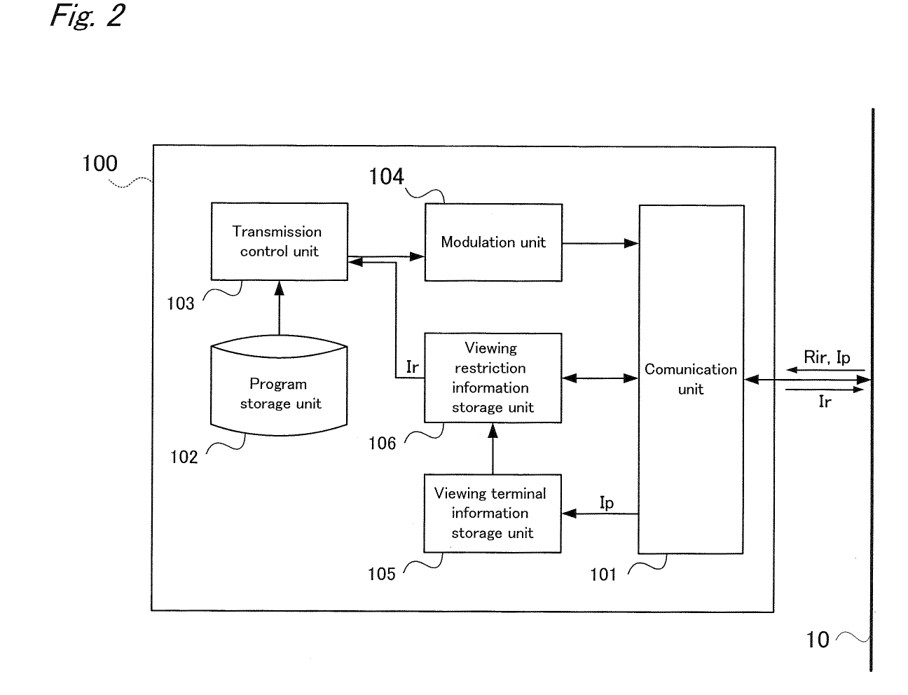

The center device 100 will be described with reference to FIG. 2. As described above, the center device 100 transmits programs to the primary viewing terminal device 200 and the secondary viewing terminal devices 300_1 and 300_2 through the communication line 10. The center device 100 includes a communication unit 101, a program storage unit 102, a transmission control unit 103, a modulation unit 104, a viewing terminal information storage unit 105, and a viewing restriction information generation unit 106. The communication unit 101 transmits video content through the communication line 10, and performs bidirectional communication with each of the primary viewing terminal device 200 and the secondary viewing terminal devices 300_1 and 300_2. There is no particular limitation on the communication protocol, encoding scheme, and modulation scheme used for the communication.

The program storage unit 102 is a medium as typified by a hard disk drive (hereinafter referred to as “HDD”), and is used to store video content. There is no particular limitation on the format in which the content is stored and medium for storing the content in the program storage unit 102.

The transmission control unit 103 functions as a video server that performs control of video content distribution. The modulation unit 104 modulates the video content to be distributed. The viewing terminal information storage unit 105 acquires information regarding the power status of the primary viewing terminal device 200, and stores the acquired information. The viewing restriction information generation unit 106 generates viewing restriction information Ir regarding the viewing restriction of the primary viewing terminal device 200 and the secondary viewing terminal devices 300_1 and 300_2.

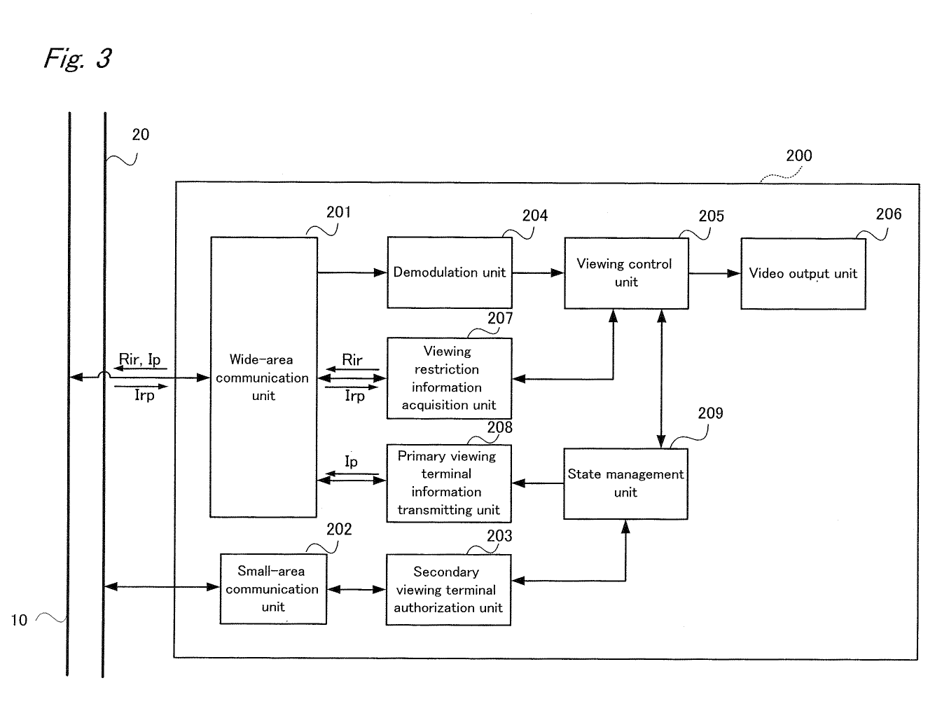

The configuration of the primary viewing terminal device 200 will be described with reference to FIG. 3. The primary viewing terminal device 200 includes a wide-area communication unit 201, a small-area communication unit 202, a secondary viewing terminal authentication unit 203, a demodulation unit 204, a viewing control unit 205, a video output unit 206, a viewing restriction information acquisition unit 207, a primary viewing terminal information transmitting unit 208, and a state management unit 209.

The wide-area communication unit 201 receives the video content transmitted from the center device 100 through the communication line 10, and performs bidirectional communication with the center device 100. There is no particular limitation on the communication protocol, encoding scheme, and modulation scheme used for the communication.

The small-area communication unit 202 performs bidirectional communication with the secondary viewing terminal device 300_1 through the communication line 20. There is no particular limitation on the communication protocol, encoding scheme, and modulation scheme used for the communication. The small-area communication unit 202 cannot communicate with the secondary viewing terminal device 300_2, which is not connected to the communication line 20.

The secondary viewing terminal authentication unit 203 determines whether or not the secondary viewing terminal devices 300_1 and 300_2 connected to the primary viewing terminal device 200 by the communication line 10 are devices covered by the same contract, that is, devices covered by the contract made by the same subscriber. The determination of devices covered by the same contract is performed based on IDs uniquely assigned to each of the secondary viewing terminal devices 300_1 and 300_2.

For example, the secondary viewing terminal authentication unit 203 pre-stores a list containing the IDs of the secondary viewing terminal devices 300_1 and 300_2 covered by the same contract. If the ID of the targeted viewing terminal device (e.g., the secondary viewing terminal devices 300_1 and 300_2, etc.) is found in the list, the targeted viewing terminal device will be authenticated as the secondary viewing terminal device covered by the same contract. The method for authenticating the secondary viewing terminal device is not limited to the above method, and other methods can be employed with which it can be determined whether or not the targeted viewing terminal device is covered by the same contract as the primary viewing terminal device 200.

The demodulation unit 204 demodulates the video content received by the primary viewing terminal device 200 from the center device 100. The viewing control unit 205 determines whether or not to allow the viewing of the received video content. If the video content is determined to be Not Allowed (Non-allowance), the restriction of viewing (viewing restriction) is placed on the video content. This viewing restriction may be performed collectively for all programs included in the broadcast video content, or separately for each program. The restriction of the programs determined to be not allowed can be as follows, for example.

The viewing terminal device can be controlled so that the channels broadcasting programs that are not allowed cannot be selected. Alternatively, the viewing terminal device can be controlled so that the programs that are not allowed are not displayed even if a channel broadcasting programs that are not allowed is selected. In either case, by rendering the viewing terminal device to not display programs that are not allowed, the user cannot view programs that are not allowed.

The video output unit 206 is a monitor that outputs the received programs in the form of video, an external output terminal that outputs the received programs to an external monitor in the form of video signals, or the like. When recording and storing programs, the video output unit 206 can be a device equipped with a storage medium such as a HDD or DVD. The viewing restriction information acquisition unit 207 acquires primary viewing restriction information Irp from the center device 100.

The primary viewing terminal information transmitting unit 208 transmits power status information Ip regarding the power status of the primary viewing terminal device 200 to the center device 100. The transmission of the power status information Ip to the center device 100 is performed in response to an information acquisition request received from the center device 100. The transmission of the power status information Ip to the center device 100 may be performed regularly or every time a change occurs in the state of the primary viewing terminal device 200 such as when the primary viewing terminal device 200 is turned on or off. There is no particular limitation on the method for transmitting information to the center device 100. The state management unit 209 manages information regarding the power status of the primary viewing terminal device 200.

The state management unit 209 manages information regarding the power status of the primary viewing terminal device 200. Regarding the power status, at least two states: ON and OFF are defined. The ON state is defined as a state in which the function for viewing video is enabled, and the transmission of power status information Ip to the center device 100 is possible. The OFF state is defined as a state in which the function for viewing video is disabled, and the transmission of power status information Ip to the primary viewing terminal device 200 is possible. In other words, even in the OFF state, the power is supplied to some of the components of the primary viewing terminal device 200, that is, to the wide-area communication unit 201, the primary viewing terminal information transmitting unit 208 and the state management unit 209.

The OFF state may be a state in which no power is supplied to the primary viewing terminal device 200 as in the case where the power cable is plugged out, or the like. In this case, the primary viewing terminal device 200 transmits the power status information Ip when it is in the ON state, but the primary viewing terminal device 200 cannot transmit the power status information Ip when it is in the OFF state. Therefore, if the power status information Ip is not transmitted to the center device 100, the center device 100 can determine that the primary viewing terminal device 200 is in the OFF state.

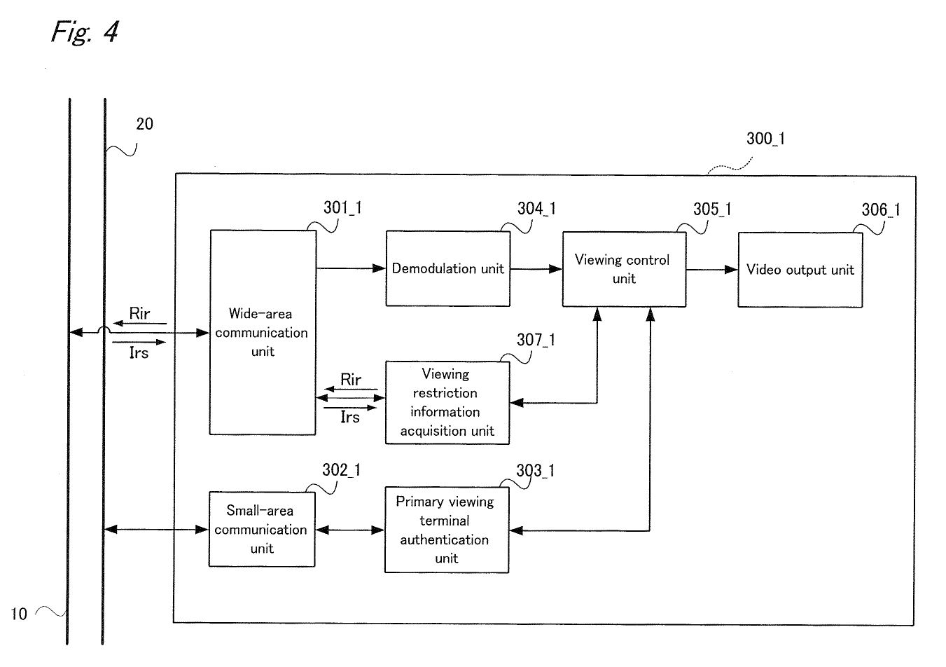

The secondary viewing terminal device 300_1 will be described with reference to FIG. 4. As described above, the secondary viewing terminal device 300_1 is connected to the center device 100, the primary viewing terminal device 200, and the secondary viewing terminal device 300_2 through the communication line 10. The secondary viewing terminal device 300_1 is connected to the primary viewing terminal device 200 also by the communication line 20. It can be understood from the foregoing that the secondary viewing terminal device 300_1 is not connected to the secondary viewing terminal device 300_2 by the communication line 20.

The secondary viewing terminal device 300_1 includes a wide-area communication unit 301_1, a small-area communication unit 302_1, a primary viewing terminal authentication unit 303_1, a demodulation unit 304_1, a viewing control unit 305_1, a video output unit 306_1, and a viewing restriction information acquisition unit 307_1.

The wide-area communication unit 301_1, the small-area communication unit 302_1, the primary viewing terminal authentication unit 303_1, the demodulation unit 304_1, the viewing control unit 305_1, the video output unit 306_1, and the viewing restriction information acquisition unit 307_1 are configured and function in the same manner as the above-described wide-area communication unit 201, small-area communication unit 202, secondary viewing terminal authentication unit 203, demodulation unit 204, viewing control unit 205, video output unit 206 and viewing restriction information acquisition unit 207 of the primary viewing terminal device 200, respectively. In other words, the secondary viewing terminal device 300 has the same configuration as that of the primary viewing terminal device 200 except that the primary viewing terminal information transmitting unit 208 and the state management unit 209 are not included.

Specifically, the viewing restriction information acquisition unit 307_1 acquires secondary viewing restriction information Irs from the center device 100. The primary viewing terminal authentication unit 303_1 determines whether or not the secondary viewing terminal device 300_1 and the primary viewing terminal device 200 are devices covered by the same contract. Similar to the secondary viewing terminal authentication unit 203, if the ID of the targeted viewing terminal device matches the ID of the primary viewing terminal device 200 covered by the same contract that has been pre-stored in the primary viewing terminal authentication unit 303_1, the primary viewing terminal authentication unit 303_1 authenticates the targeted viewing terminal device as the primary viewing terminal device 200 covered by the same contract.

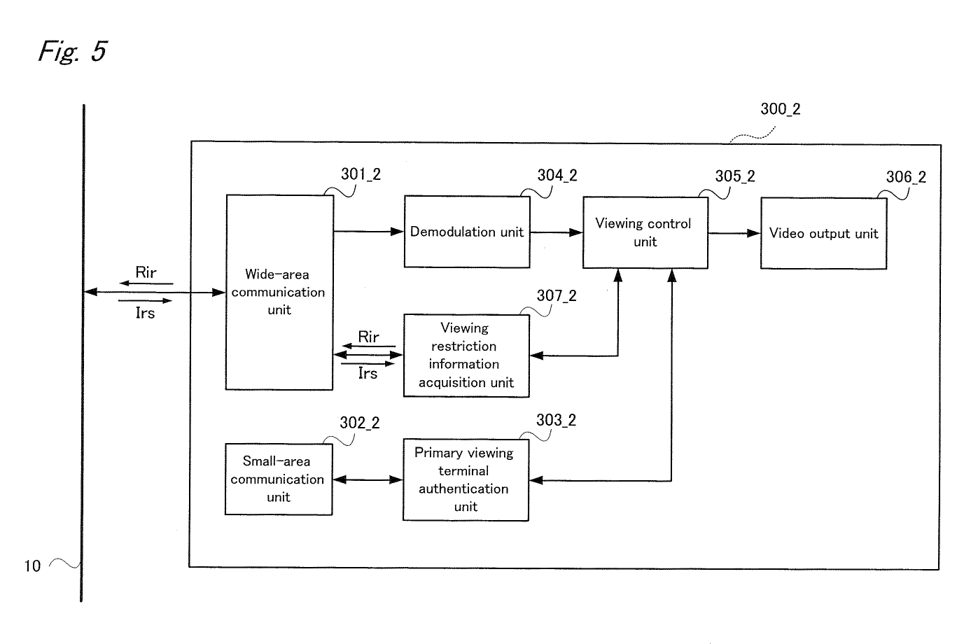

The secondary viewing terminal device 300_2 will be described with reference to FIG. 5. The secondary viewing terminal device 300_2 includes a wide-area communication unit 301_2, a small-area communication unit 302_2, a primary viewing terminal authentication unit 303_2, a demodulation unit 304_2, a viewing control unit 305_2, a video output unit 306_2, and a viewing restriction information acquisition unit 307_2. The wide-area communication unit 301_2, the small-area communication unit 302_2, the primary viewing terminal authentication unit 303_2, the demodulation unit 304_2, the viewing control unit 305_2, the video output unit 306_2, and the viewing restriction information acquisition unit 307_2 are configured and function in the same manner as the above-described wide-area communication unit 301_1, small-area communication unit 302_1, primary viewing terminal authentication unit 303_1, demodulation unit 304_1, viewing control unit 305_1, video output unit 306_1 and viewing restriction information acquisition unit 307_1.

Specifically, the viewing restriction information acquisition unit 307_2 acquires secondary viewing restriction information Irs from the center device 100. The primary viewing terminal authentication unit 303_2 determines whether or not the secondary viewing terminal device 300_2 and the primary viewing terminal device 200 are devices covered by the same contract. Similar to the primary viewing terminal authentication unit 303_1, if the ID of the targeted viewing terminal device matches the ID of the primary viewing terminal device 200 covered by the same contract that has been pre-stored in the primary viewing terminal authentication unit 303_2, the primary viewing terminal authentication unit 303_2 authenticates the targeted viewing terminal device as the primary viewing terminal device 200 covered by the same contract. Note that the secondary viewing terminal device 300_2 is not connected to the communication line 20 because the secondary viewing terminal device 300_2 is not installed in the same house as the primary viewing terminal device 200 and the secondary viewing terminal device 300_1.

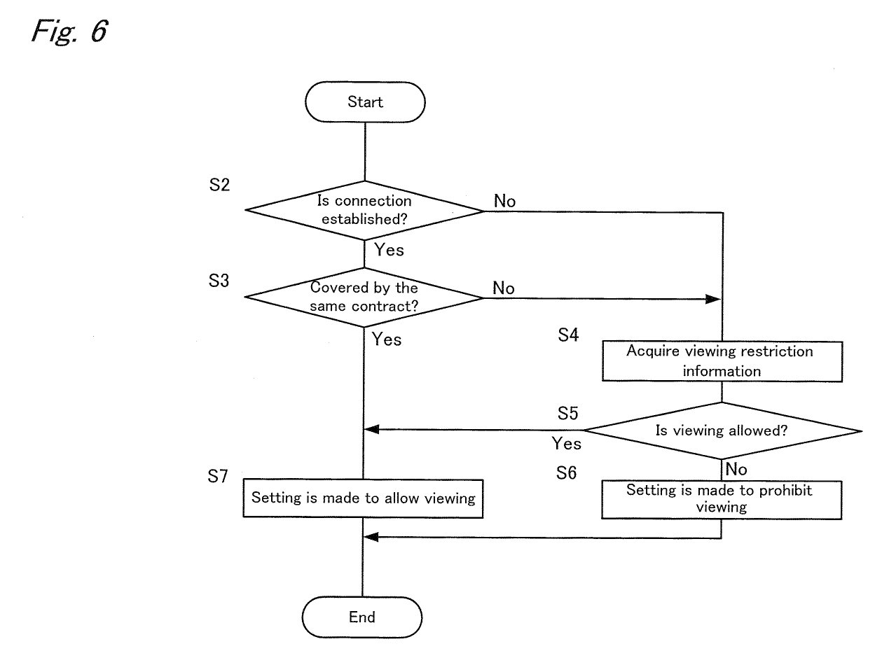

Next, the operation of the broadcast receiving system CC when the subscriber views a program with the secondary viewing terminal device 300 (the secondary viewing terminal devices 300_1 and 300_2) will be described with reference to the flowchart shown in FIG. 6. As shown in FIG. 1, in this broadcast receiving system CC, the primary viewing terminal device 200 and the secondary viewing terminal device 300_1 are installed in the same house, but the secondary viewing terminal device 300_2 is installed in a house other than the subscriber's house.

In this state, upon receiving a request to start program viewing by a secondary viewing terminal device 300 by the operation of a remote controller or the like by the user, the authentication process between the secondary viewing terminal device 300 and the primary viewing terminal device 200 starts. The items to be authenticated are whether or not the secondary viewing terminal device 300 is installed in the same house as the primary viewing terminal device 200, and whether or not the secondary viewing terminal device 300 is one of the viewing terminal devices covered by the same contract as the primary viewing terminal device 200.

First, in step S2, it is determined whether or not the secondary viewing terminal device 300 and the primary viewing terminal device 200 are installed in the same house. More specifically, if a connection to the primary viewing terminal device 200 is established through the communication line 20 which is a home LAN, it is determined that the secondary viewing terminal device 300 and the primary viewing terminal device 200 are installed in the same house. This is determined based on the fact that communication through the communication line 20 can be established when the viewing terminal devices are installed in the same house, but communication through the communication line 20 cannot be established when the viewing terminal devices are installed in different houses.

In this embodiment, as the communication line 20, a LAN using a coaxial cable for television broadcast is utilized. Basically, the secondary viewing terminal device 300_2 installed in the house of a neighbor is not connected to the home LAN of the subscriber, and thus it is possible to determine whether or not the secondary viewing terminal device 300_2 is installed in the same house as the secondary viewing terminal device 300_1 by the establishment of a connection.

Alternatively, even if the secondary viewing terminal device 300_2 is physically connected to the coaxial cable of the communication line 20, it is possible to determine whether or not the secondary viewing terminal device 300_2 is installed in the same house as the secondary viewing terminal device 300_1. The determination can be made based on the feature that, in networks using a coaxial cable, the signals are attenuated significantly with increasing distance or increasing number of intermediate devices such as a splitter, and therefore, it is almost impossible for the viewing terminal device that is connected with the coaxial cable and is installed in a house other than the subscriber's house to perform communication through the communication line 20.

Further, by providing a filter that passes only signals of a predetermined frequency band to the connection point connecting to the outside, it is also possible to completely block the communication to a house other than the subscriber's house. More specifically, in this step S2, if a communication link can be established through the small-area communication unit 302_1, it is determined that the primary viewing terminal device 200 is installed in the same house as the secondary viewing terminal device 300.

The communication line 20 can be any communication line capable of communicating with a house other than the subscriber's house as long as it is possible to determine whether the viewing terminal device to be communicated with (the primary viewing terminal device 200 or secondary viewing terminal device 300) is installed in the subscriber's house or in a house other than the subscriber's house. For example, when using Ethernet as the communication line 20 and performing communication using TCP/IP protocols on the communication line 20, a method may be employed in which whether the viewing terminal device to be connected is installed in the subscriber's house or a house other than the subscriber's house is determined by changing the TTL (time to live) value of packets to be transmitted or observing the RTT (round trip time) value of received packets. In the case of changing TTL values, appropriate TTL values are set for packets to be transmitted so that the packets do not reach a house other than the subscriber's house. If the packets are received and there is a response from the viewing terminal device, it is determined that the targeted viewing terminal device (in this example, the primary viewing terminal device 200) is installed in the same house. In the case of using RTT values, if the RTT values of the received packets are not greater than a predetermined value, it is determined that the targeted viewing terminal device is installed in the same house. Such methods that can determine whether the targeted viewing terminal device is in the subscriber's house or a house other than the subscriber's house can be used.

In this example, if the primary viewing terminal device 200 is turned on, and the secondary viewing terminal device 300 is turned on, Yes is determined for the secondary viewing terminal device 300_1, and the control advances to the next step S3. On the other hand, No is determined for the secondary viewing terminal device 300_2, and the control advances to step S4. The secondary viewing terminal devices 300_1 and 300_2 cannot communicate with the primary viewing terminal device 200 if the primary viewing terminal device 200 is turned off, and therefore No is determined, and the control advances to step S4.

To be more precise, in this step, it is possible to determine whether or not the communication between the primary viewing terminal device 200 and the secondary viewing terminal device 300 can be established. However, the determination of the viewing terminal devices that are installed in the same house is affected by the power status (ON/OFF), communication conditions, and communication quality of the viewing terminal devices.

In step S3, it is determined that whether or not the secondary viewing terminal device 300 determined to be installed in the same house in step S2 is covered by the same contract as the primary viewing terminal device 200. More specifically, as described above, this is determined by the secondary viewing terminal authentication unit 203 of the primary viewing terminal device 200 and the primary terminal authentication unit 303 of the secondary viewing terminal device 300 (the primary terminal authentication units 303_1 and 303_2 are collectively called “the primary terminal authentication unit 303”), based on whether or not the assigned IDs can be found in the stored list.

Methods other than the above can be used as long as it is possible to properly determine that the primary viewing terminal device 200 and the secondary viewing terminal device 300 are covered by the same contract. In this example, Yes is determined for the secondary viewing terminal device 300_1, and the process advances to step S7. Also, in this example, n=2, or in other words, two terminal devices such as the secondary viewing terminal devices 300_1 and 300_2 are used; however, if a secondary viewing terminal device 300_3 that is installed in the same house as the primary viewing terminal device 200 but is not covered by the same contract is present, No is determined for the secondary viewing terminal device 300_3 in this step, and the process advances to step S4.

In step S4, secondary viewing restriction information Irs of the secondary viewing terminal device 300 determined as No in step S2 or S3 described above, that is, the secondary viewing terminal device 300 determined to be in a house other than the subscriber's house where the primary viewing terminal device 200 is installed, or determined not to be covered by the same contract, is acquired. In this example, the viewing restriction information acquisition unit 307_2 of the secondary viewing terminal device 300_2 acquires the secondary viewing restriction information Irs from the center device 100. Then, the control advances to the next step, step S5.

As described above, the viewing restriction information Ir is generated by the viewing restriction information generation unit 106 of the center device 100. The method for generating the viewing restriction information Ir will be described later, but basically, program viewing is allowed for a secondary viewing terminal device 300 properly used within the scope of the contract (in this example, the secondary viewing terminal device 300_1), and program viewing is restricted or prohibited for a secondary viewing terminal device 300 used in an unauthorized manner by the lending out to a neighbor or the like (in this example, the secondary viewing terminal device 300_2).

In step S5, it is determined whether or not to allow viewing for the secondary viewing terminal device 300 (in this example, the secondary viewing terminal device 300_2) based on the viewing restriction information Ir acquired in step S4. This determination of the allowance/non-allowance of viewing for the secondary viewing terminal device 300 based on the secondary viewing restriction information Irs is performed taking into consideration the possibility that No is determined for the secondary viewing terminal device 300_1 installed in the same house (i.e., the possibility that the secondary viewing terminal device 300_1 is determined to be installed in a house other than the subscriber's house) in step S2 due to the primary viewing terminal device 200 being turned off. In this step, if it is determined that viewing is not allowed (No), the control advances to step S6. If it is determined that viewing is allowed (Yes), the control advances to step S7.

In step S7, a setting is made to allow viewing for the secondary viewing terminal device 300 (in this example, the secondary viewing terminal device 300_1) based on the determination result obtained in steps S3 and S5 described above. In this case, the program transmitted from the center device 100 is received through the wide-area communication line 10 and the wide-area communication unit 301 (in this example, the wide-area communication unit 301_1), is demodulated and decoded by the demodulation unit 304 (in this example, the demodulation unit 304_1), and then is outputted to the video output unit 306 (in this example, the video output unit 306_1).

In step S6, a setting is made to prohibit viewing for the secondary viewing terminal device 300 (in this example, the secondary viewing terminal device 300_2) based on the determination result obtained in step S5 described above. In this case, the video signals received are not outputted to the video output unit 306 (in this example, the video output unit 306_2). Instead, video signals other than the received video signals are outputted to the video output unit 306 (in this example, the video output unit 306_2), or the like, so as to restrict the viewing of the programs prohibited by the user.

As described above, the primary terminal authentication unit 303 and the secondary viewing terminal authentication unit 203 are connected to the center device 100 serving as a broadcast source through the same communication medium, namely, the communication line 10. By performing the authentication of whether or not the viewing terminal device is installed in the same house through the communication line 10 that is used also to receive video content broadcasts, the authentication and program viewing with the viewing terminal device are performed indivisible. In other words, higher responsivity between the result of the authentication and the determination of the viewing control (allowance/non-allowance) is secured.

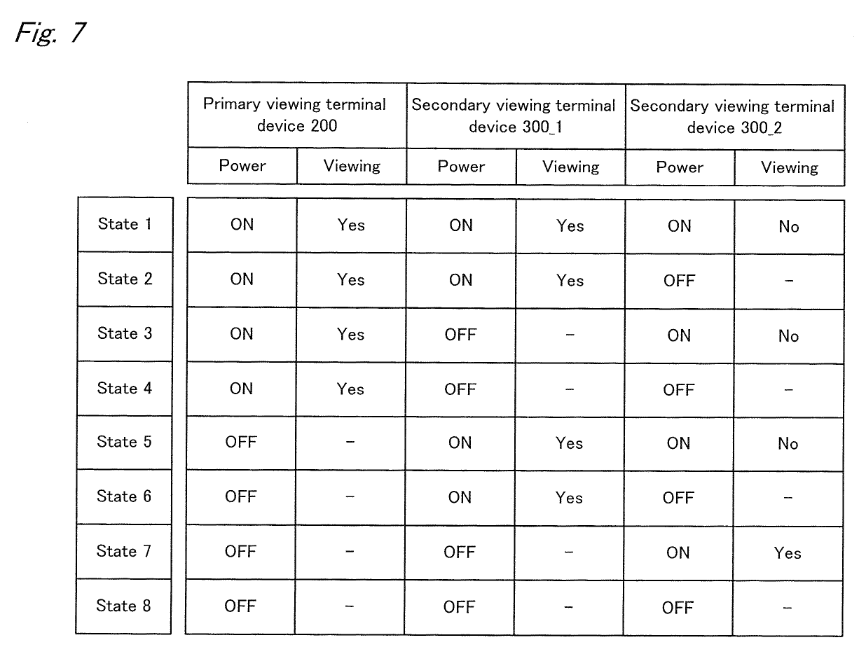

The viewing restriction of each of the primary viewing terminal device 200, and the secondary viewing terminal devices 300_1 and 300_2 will be described with reference to FIG. 7. In this table, States 1 to 8 represent the power status (ON/OFF) and the allowance (Yes)/non-allowance (No) of viewing in States 1 to 8 for each of the primary viewing terminal device 200, and the secondary viewing terminal devices 300_1 and 300_2. The hyphen (−) represents that the determination of allowance/non-allowance of viewing cannot be made because the targeted viewing terminal device is turned off.

In State 1, the primary viewing terminal device 200, and the secondary viewing terminal devices 300_1 and 300_2 are all turned on. As shown in FIG. 1, in the broadcast receiving system CC, the primary viewing terminal device 200 and the secondary viewing terminal device 300_1 are installed in the subscriber's house, but the secondary viewing terminal device 300_2 is installed in a house other than the subscriber's house. Accordingly, program viewing is allowed for the primary viewing terminal device 200 and the secondary viewing terminal device 300_1, but program viewing is prohibited (not allowed) for the secondary viewing terminal device 300_2. Similarly, the power status (ON/OFF) and the allowance (Yes)/non-allowance (No) of viewing in States 2 to 8 for each of the primary viewing terminal device 200, the secondary viewing terminal devices 300_1 and 300_2 can be seen in the same procedure as described above.

Specifically, program viewing is allowed for the primary viewing terminal device 200 in States 1, 2, 3 and 4 in which the primary viewing terminal device 200 is turned on. As used herein, the phrase “viewing is allowed” means that the programs that are allowed by the original contract for viewing subscription are allowed, but does not mean that the viewing of all programs, including those not covered by the original contract (e.g., pay programs, etc.), is allowed.

As for the secondary viewing terminal device 300_1, program viewing is allowed in States 1, 2, 5 and 6, in which its power is ON. This is because the secondary viewing terminal device 300_1 is formally covered by the contract for viewing subscription, and thus program viewing should be possible even in States 5 and 6 in which the primary viewing terminal device 200 is not turned on. This is intended to enhance convenience for the user, and to eliminate the restriction that the primary viewing terminal device 200 has to be turned on whenever program viewing is performed with the secondary viewing terminal device 300 properly covered by the contract (in this example, the secondary viewing terminal device 300_1).

In States 5 and 6, in which the primary viewing terminal device 200 is not turned on, the secondary viewing terminal device 300 (regardless of whether it is the secondary viewing terminal device 300_1 or 300_2) cannot connect to the primary viewing terminal device 200, and therefore No is determined in step S2 described above, and the secondary viewing terminal device 300 acquires secondary viewing restriction information Irs from the center device 100 in step S4. In other words, “viewing allowed” is set for the secondary viewing terminal device 300 in the secondary viewing restriction information Irs. This enables viewing with the secondary viewing terminal device 300 (in this example, the secondary viewing terminal device 300_1).

The center device 100 cannot determine whether or not the secondary viewing terminal device 300 is installed in the area covered by the contract. For this reason, even if a request for viewing is made from the secondary viewing terminal device 300 covered by the same contract, the center device 100 is set not to allow viewing without restriction, but to allow viewing within a scope in which the service provider experiences no losses. The details thereof will be described below.

In this example, the secondary viewing terminal device 300_2 is used in an unauthorized manner. Therefore, basically, viewing should be prohibited for the secondary viewing terminal device 300_2 under any circumstances. However, according to this embodiment, a setting is made so that viewing is allowed also for the secondary viewing terminal device 300_2 within a scope in which the service provider experiences no losses.

For example, assume that 3,000 yen per month is charged for the primary viewing terminal device 200, and 500 yen per month is charged for the secondary viewing terminal devices (the secondary viewing terminal devices 300_1 and 300_2). If such a billing system is applied to the broadcast receiving system shown in FIG. 1, the fee that the subscriber pays to the provider will be 4,000 yen (i.e., the total of the usage fee for the primary viewing terminal device 200 (3,000 yen), that for the secondary viewing terminal device 300_1 (500 yen), and that for the secondary viewing terminal device 300_2 (500 yen)).

On the other hand, the fee that the service provider should have to receive in States 1, 3, 5 and 7 will be as follows. The fee per month in State 1 will be 6,500 yen (the total of the usage fee for the primary viewing terminal device 200 (3,000 yen), that for the secondary viewing terminal device 300_1 (500 yen), and that for the secondary viewing terminal device 300_2 (3,000 yen)).

The fee in State 3 will be 6,000 yen (the total of the usage fee for the primary viewing terminal device 200 (3,000 yen), that for the secondary viewing terminal device 300_1 (0 yen), and that for the secondary viewing terminal device 300_2 (3,000 yen)). The fee in State 5 will be 6,000 yen (the total of the usage fee for the primary viewing terminal device 200 (0 yen), that for the secondary viewing terminal device 300_1 (3,000 yen), and that for the secondary viewing terminal device 300_2 (3,000 yen)). The fee in State 7 will be 3,000 yen (the total of the usage fee for the primary viewing terminal device 200 (0 yen), that for the secondary viewing terminal device 300_1 (0 yen), and that for the secondary viewing terminal device 300_2 (3,000 yen)).

It can be seen from the foregoing that the service provider will experience losses in States 1, 3 and 5, but will not experience losses in State 7. Accordingly, the viewing for the secondary viewing terminal device 300_2 is allowed within a scope in which the service provider experiences no losses (State 7); otherwise, however, the viewing for the secondary viewing terminal device 300_2 is prohibited (States 1, 3 and 5). Similar to the billing, the allowance/non-allowance based on the states is determined on a monthly basis. In other words, in the case where billing is charged on a daily basis, for example, the allowance of viewing for the secondary viewing terminal device 300_2 may be determined on a daily basis in State 7.

In States 1 and 3, although the primary viewing terminal device 200 is turned on, the secondary viewing terminal device 300_2 requests secondary viewing restriction information Irs from the center device 100. This indicates that authentication is not successful between the secondary viewing terminal device 300_2 and the primary viewing terminal device 200. Accordingly, it can be determined that the secondary viewing terminal device 300_2 is an unauthorized viewing terminal device installed in an area other than that covered by the contract. This determination can be utilized in step S3 above.

In State 5, the center device 100 first receives a viewing restriction information request Rir both from the secondary viewing terminal devices 300_1 and 300_2. The center device 100 counts the number of secondary viewing terminal devices 300 that have already been allowed to receive program (in this example, the secondary viewing terminal device 300_1), and if it is determined that no loss will be caused to the service provider even if viewing is allowed for the secondary viewing terminal device 300 requesting the secondary viewing restriction information Irs, the center device 100 allows viewing. If it is determined that a loss will be caused, the center device 100 prohibits viewing. In this example, one secondary viewing terminal device 300_1 is already receiving a program, and thus if viewing is allowed for the second secondary viewing terminal device 300_2, a loss will be caused; therefore, viewing will be prohibited for the second secondary viewing terminal device 300_2.

Similarly, in State 7, if it is determined that no loss will be caused to the service provider even if viewing is allowed for the secondary viewing terminal device 300 requesting the secondary viewing restriction information Irs, the center device 100 allows viewing. If it is determined that a loss will be caused, the center device 100 prohibits viewing. In this example, the secondary viewing terminal device 300_1 is not receiving a program, and thus even if viewing is allowed for the secondary viewing terminal device 300_2 requesting the secondary viewing restriction information Irs, no loss will be caused. Therefore, viewing will be allowed for the secondary viewing terminal device 300_2.

When viewing is no longer possible with the viewing terminal device that has once been allowed to receive program (in this example, the secondary viewing terminal device 300_2), a setting can be made so that program viewing cannot be executed until the authentication between that viewing terminal device and the primary viewing terminal device 200 is successful, or the like, in order to prevent continuous unauthorized use. It is also possible to impose severe punishments on the viewing terminal device that can no longer receive program (in this example, the secondary viewing terminal device 300_2) such as disabling the viewing terminal device from program viewing after that, so as to further improve deterrence.

Further, in the case of States 5 and 6 in which the primary viewing terminal device 200 is turned off and program viewing is executed with the secondary viewing terminal device 300 (the secondary viewing terminal device 300_1), or in the case of State 7 (the secondary viewing terminal device 300_2), a message indicating that the primary viewing terminal device 200 is turned off, or a message prompting the user to turn on the primary viewing terminal device 200, may be displayed in the secondary viewing terminal device 300. These messages may be displayed before a program is displayed, or concurrently with the display of a program. There is no particular limitation on the location in which the messages are displayed, the display form, and the method of displaying the messages.

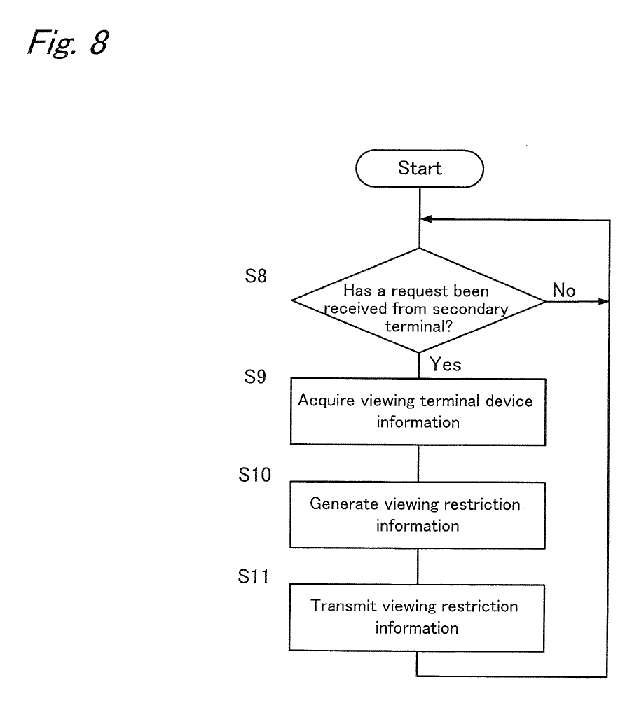

Next, the method for transmitting secondary viewing restriction information Irs from the center device 100 to the secondary viewing terminal device 300 will be described with reference to FIG. 8. The center device 100 is assumed to be in a state where it is waiting for a viewing restriction information request Rir that requests secondary viewing restriction information Irs from the secondary viewing terminal device 300.

Specifically, in step S8, it is determined whether or not a viewing restriction information request Rir has been received from the secondary viewing terminal device 300. Upon receiving the viewing restriction information request Rir, the control advances to the next step, step S9.

In step S9, the content of the received viewing restriction information request Rir is first analyzed. The viewing restriction information request Rir includes at least the ID of the secondary viewing terminal device 300 (in this example, the secondary viewing terminal device 300_1 or 300_2) that has made the request, and the ID of the primary viewing terminal device 200 covered by the same contract as the secondary viewing terminal device 300. The center device 100 acquires power status information Ip indicative of the power status (ON/OFF) of the primary viewing terminal device 200 possessing the ID through the communication line 10 based on the ID of the primary viewing terminal device 200 acquired from the viewing restriction information request Rir.

The acquired IDs of the secondary viewing terminal device 300 and the primary viewing terminal device 200, as well as the power status information Ip of the primary viewing terminal device 200, are stored in the viewing terminal information storage unit 105. The viewing terminal information storage unit 105 temporarily stores the IDs of the secondary viewing terminal device 300 (the secondary viewing terminal device 300_1, 300_2) that has requested the viewing restriction information request Rir upon receiving the viewing restriction information request Rir, and does not necessarily store the IDs of all viewing terminal devices connected to the communication line 10 (the primary viewing terminal device 200, and the secondary viewing terminal devices 300_1 and 300_2). In other words, the center device 100 does not have to manage the IDs of all viewing terminal devices (the primary viewing terminal device 200, and the secondary viewing terminal devices 300_1 and 300_2) and their primary/secondary relationship.

The viewing restriction information request Rir does not necessarily include the ID of the primary viewing terminal device 200. However, the IDs of all viewing terminal devices (the primary viewing terminal device 200, and the secondary viewing terminal device 300) and their primary/secondary relationship need to be managed by the center device 100. For this purpose, a list containing the IDs of the primary viewing terminal device 200 and the secondary viewing terminal device 300 (the secondary viewing terminal device 300_1, 300_2) covered by the same contract is pre-stored in the center device 100. Furthermore, the ID of the secondary viewing terminal device that has transmitted the viewing restriction information request Rir (in this example, the secondary viewing terminal device 300_1 or 300_2), and the ID of the primary viewing terminal device 200 covered by the same contract, are searched for in order to identify the primary viewing terminal device 200 that should acquire terminal device information including the power status information Ip.

Next, in step S10, secondary viewing restriction information Irs of the secondary viewing terminal device 300 that has transmitted the viewing restriction information request Rir is generated by the viewing restriction information generation unit 106 based on the acquired primary terminal device information. The secondary viewing restriction information Irs is set in the same manner as described above with reference to FIG. 7. As already described, the viewing restriction information generation unit 106 also generates primary viewing restriction information Irp.

As shown in FIG. 7, in this example, basically, all viewing is allowed for the primary viewing terminal device 200. However, if the unauthorized use of the secondary viewing terminal device 300 (in this example, the secondary viewing terminal device 300_2) is detected, the viewing with the primary viewing terminal device, as well as the viewing with the secondary viewing terminal device 300, may be prohibited. This is because when the secondary viewing terminal device 300 is found to be used in an unauthorized manner, the user of the primary viewing terminal device is deemed to be involved in the unauthorized use. The imposition of severe punishments in response to the discovery of unauthorized use is intended to deter further unauthorized use.

In step S11, viewing restriction information Ir (the secondary viewing restriction information Irs and the primary viewing restriction information Irp) are transmitted to the secondary viewing terminal device 300 and the primary viewing terminal device 200, respectively, through the communication line 10.

Subsequently, the center device 100 again enters the standby state. The secondary viewing terminal device 300 and the primary viewing terminal device 200 allow or prohibit program viewing based on the received viewing restriction information Ir.

The information regarding viewing control may be reflected in the operation of the viewing terminal device immediately upon acquiring the viewing restriction information Ir, or at another timing such as when the viewing terminal device is turned on/off the next time, rather than immediately upon acquiring the viewing restriction information Ir.

In this embodiment, the communication line 10 is configured of a coaxial cable capable of bidirectional communication. However, in some cases, the upload line may not be used. In such a case, the viewing restriction information request Rir from the secondary viewing terminal device 300 is not received by the center device 100, and thus the viewing restriction information acquisition unit 307 cannot acquire the secondary viewing restriction information Irs. In this case, the video output unit 306 sends the user a message indicating that program viewing is not executable due to the primary viewing terminal device 200 not being on. Instead of sending such a message, an indication prompting the user to turn on the primary viewing terminal device 200 may be used. With these message and indication, the user can learn the cause for not being able to receive program, as well as its solution.

The information transmitted from the primary viewing terminal device 200 is not limited to the power status information Ip. For example, a notification indicating that the network function is disabled may be transmitted to the center device 100, rather than the power status of the primary viewing terminal device 200, in the case where communication between the primary viewing terminal device 200 and the secondary viewing terminal device 300 cannot be established through the LAN due to temporary disablement of the network function, or the like, even though the primary viewing terminal device 200 is turned on. In this case, the center device 100 can determine whether or not to allow viewing for the secondary viewing terminal device 300 based on the acquired information.

As described above, in this embodiment, the viewing restriction information Ir to be generated is set so that viewing is allowed for the secondary viewing terminal device 300 within a scope in which the service provider does not experience losses that can be caused by, for example, failing to collect fees. This is to achieve both the prevention of unauthorized use of the viewing terminal device and the improvement in convenience for the user. However, the foregoing is merely exemplary, and there is no limitation on the method for generating the viewing restriction information Ir. For example, the number of secondary viewing terminal devices 300 to be allowed to receive programs may be set to a fixed value.

The present invention is useful as a broadcast receiving system that broadcasts programs and performs bidirectional communication by utilizing a communication line such as a coaxial cable, such as a CATV system.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A broadcast receiving system that is provided with one primary viewing terminal device and a predetermined number of secondary viewing terminal devices subordinate to said primary viewing terminal device, and that performs bidirectional communication between said primary viewing terminal device and a center device, and between said secondary viewing terminal device and said center device,
wherein said center device generates secondary viewing restriction information regarding the viewing control of said secondary viewing terminal devices based on at least the power status of said primary viewing terminal device, and
said secondary viewing terminal device comprises:
a viewing terminal device authentication means for authenticating that said secondary viewing terminal device is installed in the same house as said primary viewing terminal device;
a viewing restriction information acquisition means for acquiring said secondary viewing restriction information from said center device; and
a viewing control means for controlling the viewing of programs broadcast from said center device based on the result of the authentication performed by said viewing terminal device authentication means and said acquired secondary viewing restriction information.

2. The broadcast receiving system in accordance with claim 1, wherein said secondary viewing restriction information is generated so as to allow viewing for said secondary viewing terminal device within a scope in which no loss is caused to a service provider.

3. The broadcast receiving system in accordance with claim 1, wherein the authentication performed by said viewing terminal device authentication means uses a medium that is also used as a communication medium to receive broadcast waves.

4. The broadcast receiving system in accordance with claim 1, wherein when the authentication by said viewing terminal device authentication means is unsuccessful, said secondary viewing terminal device displays an indication that said primary viewing terminal device is not turned on.

5. A broadcast receiving system that is provided with one primary viewing terminal device and a predetermined number of secondary viewing terminal devices subordinate to said primary viewing terminal device, and that performs bidirectional communication between said primary viewing terminal device and said secondary viewing terminal devices and a center device,
wherein said center device generates primary viewing restriction information regarding the viewing control of said primary viewing terminal device based on at least the power status of said primary viewing terminal device and a request from said secondary viewing terminal devices, and
said primary viewing terminal device comprises:
a viewing restriction information acquisition means for acquiring said primary viewing restriction information from said center device; and
a viewing control means for controlling the viewing of programs broadcast from said center device based on said primary viewing restriction information.
